(19) United States
(12) Patent Application Publication
(10) Pub. No.: US 2025/0207956 A1
(43) Pub. Date: Jun. 26, 2025

(54) INSULATION SYSTEM FOR PROCESS INSTRUMENT ENCLOSURES THAT PROVIDE HEATING AND COOLING

(71) Applicant: Terrapin Industrial, LLC, Houston, TX (US)

(72) Inventors: Brad Faseler, Houston, TX (US); Daniel Tagtow, Austin, TX (US); Matthew Nance, Boling, TX (US); James E. Bundschuh, Fenton, MO (US)

(73) Assignee: Terrapin Industrial, LLC, Houston, TX (US)

(21) Appl. No.: 18/974,322

(22) Filed: Dec. 9, 2024

Related U.S. Application Data
(60) Provisional application No. 63/614,206, filed on Dec. 22, 2023.

(51) Int. Cl. G01D 11/24; G01D 11/30

(52) U.S. Cl. CPC G01D 11/245; G01D 11/30

(57) ABSTRACT

A thermally controlled instrument enclosure including customizable heater liner system used to heat, or cool, inside of an instrument enclosure, and more specifically for winterization of the inside space of the enclosure from ambient climate conditions and insulate from cold and the resulting freeze causing the process feeding the instrument and instrument manifold to freeze. The method of mounting a heated liner system, allowing for heater cables to be routed in a way to uniformly heat the entire internal area of a rigid or semi-rigid housing or enclosure to protect and/or insulate a field mounted instrument preferably including a liner with a method to hold the heater cable securely to the liner, with a layer or multiple layers of insulation added to the heater cable, so that the insulation system holds the heat in and eliminates the heat loss that naturally occurs when heating enclosures with instruments in cold conditions.

### PRIORITY

This application is a nonprovisional conversion of and claims priority to U.S. Provisional Application 63/614,206 filed Dec. 22, 2023, entitled “Insulation System for Process Instrument Enclosures That Provide Heating and Cooling”, the entirety of which are incorporated by reference herein.

### BACKGROUND

In various industries including, by way of example, petrochemical, mineral refining, food processing, gas compression, and gas processing, process instrumentation is frequently remote mounted in the field and often times enclosed inside of a box for winterization protection along with a heater to heat the inside of the enclosure containing the process instrument, sometimes for freeze protection, and sometimes at an elevated process temperature to ensure no condensation occurs or to keep the fluid flowing. Currently, heaters are installed in rigid boxes in more critical applications and in very cold climates. Rigid boxes require all of the instrument components to be mounted inside of the hard enclosure, using various brackets and fastening means, and fastened to a pole stand. Rigid box enclosures have limitations and drawbacks. Mounting all of the various components inside of the enclosure can, of itself, present significant complexity. Conventional rigid enclosures are not generally suitable for enclosing field instruments that are directly attached to a standpipe or the like. When a field instrument is to be enclosed with a conventional rigid enclosure, the field instrument is first affixed within the instrument enclosure and the enclosure, rather than the field instrument, is attached to the standpipe. Many mounting brackets may be required to arrange the instrument into the rigid box in such a way that allows the instrument enclosure to be opened and closed. In addition, when, as is sometimes the case, the enclosure needs to be replaced, the heaters and other components have to then be removed from their mounting locations inside of the enclosure. Further, when the heater needs to be replaced or maintained, it is difficult to remove the heater from such congested spaces as they are bolted down and it becomes extremely difficult to use available field tools to loosen the bolts in order to remove the heater due to interference with or from multiple components inside of the enclosure.

Finned Heaters and Block Heaters that are presently used to heat the inside of the enclosures, have several inherent deficiencies compared to other heating devices for industrial use in hazardous area locations. The Finned or Block Heaters require a fail-safe thermal fuse to be installed in order to break the circuit if the temperature of the heater body rises above the CSA (Canadian Standards Association) or IEEE certified rating for that heating device. Most all Finned or Block heaters are rated for a maximum temperature of T3 (392° F.). The Thermal Fuse that is used to ensure that the heater never exceeds that temperature, has a meltable core; therefore, opening the circuit and stopping all current going to the heater to prevent overheating and system failure. There are many instances of these thermal fuses failing prematurely for various reasons, such as poor grounding systems or inconsistent supply voltages. Once the thermal fuse opens, the instrument enclosure it is designed to heat, will freeze, a frequent problem when temperatures drop below freezing.

Removable insulation and a metal or thermostable non-metal liner with heater cables affixed to the liner with tabs or other connecting apparati, serves as a convection heating system in conjunction with the insulation system and an outer liner which pins the insulation system to the heater cable affixed to the liner, creating a convection heater that provides thorough distribution of heat to the entire inside liner section, providing unequalled performance as compared to the standard finned heaters and block heaters used today.

The thermally controlled instrument enclosure utilizing a customizable heater liner system provides superior heating performance and also removes the large, finned heaters, the conduit, and GUAT junction boxes from the interior of the enclosure. The GUAT is a style of box that is used in hazardous locations. All GUA style boxes are supplied PVC coated with PVC coated covers and a seal between the coating of the boxes and the coating of the covers. Current instrument enclosures possess limited interior space; therefore, installing the heater cable to a liner and insulation system, instantly increases the usable cubic space in the enclosure typically taken up by the GUAT, conduits, and mounting apparatus commonly used to mount a heater inside of an instrument enclosure.

In extremely cold arctic conditions, the finned and block heaters become larger and larger as they increase from a typical 100-watt output to a 150-watt, 200-watt, 300-watt, 400-watt output. The thermally controlled instrument enclosure utilizing a customizable heater liner system eliminates the need for these larger heaters by having the ability to provide much higher wattage outputs, upwards of 800-watt to 900-watt. The heating elements are hidden behind the liner, out of the way of the enclosure interior, out of harm's way of operators who may rub up against the finned heaters, freeing up much needed space to mount the instrumentation equipment that these enclosures are built to protect.

### SUMMARY

Thermally controlled instrument enclosures utilizing a heated liner system address problems that may arise with typical rigid enclosures incorporating heating, cooling, or other means of temperature control within the enclosure as required by climate demands or instrument sensitivity. These thermally controlled instrument enclosures remove the need for large finned heaters inside of the instrument enclosure by lining a liner with heater cable using heater cable routing tabs strategically located and engineered to length and design, in conjunction with heat trace cables of various outputs which provide an ample amount of heat to be added to the enclosed space, in order to keep the instrument and process tubing that tie into the instrument, in a flowing condition, therefore protecting them from freezing.

The thermally controlled instrument enclosure allows for a field instrument that is mounted directly to a standing structure, such as a conventional 2″ standpipe or the like, to be enclosed, in the field, within an enclosed space defined by the instrument enclosure, while distributing heat more evenly across the entire liner of the enclosure, creating a much more uniform heating and/or cooling system for maintaining a thermal equilibrium and eliminating heat loss.

The customizable thermally controlled instrument enclosure is retrofittable and a simpler pre-engineered standardized solution requiring much less mounting hardware, and containing an insulation system with removeable liner components that can be taken in and out of the enclosure, allowing for flexibility to increase or decrease the insulation type and thickness in order to meet various cold climate temperature demands impacting the heat loss requirement necessary to properly heat the enclosure. Throughout this disclosure cooling systems can be substituted for heating systems where the cooling system includes various known cooling systems such as air conditioners and compressors, vortex tubes, cryogenic devices and even water-cooled fins. Thermally controlled instrument enclosures utilizing a heated liner system may be replaced without taking the field instrument offline and the time required to replace thermally controlled instrument enclosures and or components of the heated liner system is much less than time required to replace conventional rigid enclosures and/or devices used to heat the inside of the enclosure.

Thermally controlled instrument enclosures may reduce or eliminate expensive travel and the tedious process of walking around the applicable facility to first locate each instrument and then creating a custom template. Thermally controlled instrument enclosures utilizing a heated liner system can also be used for covering inline instruments, valves, regulators, and other appurtenances that would need to maintain a specified thermal profile.

Heated liner thermally controlled field-mounted instrument enclosures, including rigid and semi-rigid enclosures, protect field instruments from severe ambient conditions by providing a barrier between the enclosed space and the environment external to the enclosed space while providing thermally controlled regulation to the enclosed space. The barrier shields the enclosed space from one or more environmental elements including, as non-limiting examples and depending on the embodiment, temperature extremes, precipitation, frost, snow, humidity, wind, sunlight, environmental debris, wild animals, and unauthorized persons. Additional embodiments of the present disclosure may employ seals, gaskets, or the like using known materials such as silicon or silicon-based compounds to improve the moisture barrier provided by the thermally controlled instrument enclosure in the closed position. Other embodiments allow for a universally sized box with a heated liner system to completely enclose a field instrument without taking the field instrument off-line, removing the field instrument from a standpipe mount, or mounting the field instrument within an instrument enclosure using various brackets while also removing the requirement for additional mounting of accessories to maintain internal temperature equilibrium.

Thermally controlled instrument enclosures utilizing a heated liner system may include a top section, also sometimes referred to herein as a hinged section, and a bottom section, also referred to herein as a fixed section. The bottom section may include two parts, which may be hinged or affixed in a manner that permits the bottom to be opened and wrapped around a field instrument or other object mounted to a pipe or a standpipe. The two parts of the bottom section may be configured to wrap around a portion of the standpipe or other support, a portion of the tubing or tubing bundle carrying a process fluid, and a portion of any power wire(s) and/or communication wire(s) fixed to the field instrument.

Thermally controlled with an optional thermostat instrument enclosures may further include a hinge or fastening means which is suitable for attaching the top section of the instrument enclosure to the bottom section once the bottom section is in place.

More specifically, the present disclosure describes one or more instrument enclosures, comprising: a top section casing with a first, second, third, and fourth edge and bottom section casing with a first, second, third, and fourth edge, wherein the first edge of the bottom section casing is hinged and/or rotatably-affixed to the first edge of the top section casing via one or more hinges and wherein second, third, and fourth edges of the top casing section are in contact with or in close proximity to the second, third, and fourth edges of the bottom section casing that provides an insulating housing that includes individual interchangeable parts that provide a portion of or completed separate attachable interior liner and exterior cap for the housing that encloses at least a portion of the instrument enclosures such that one or more instruments within the enclosures are temperature controlled and wherein the enclosures are rotatable and wherein one or more hinges are configured to enable both the top section casing and the bottom section casing to rotate between a close positioned and one or more open positions.

The embodiments of the instrument enclosures provide wherein the separate interior liner of the housing is comprised of either a stamped liner with tabs stamped through the liner for attachment of at least two separate pieces to the separate interior liner and/or a welded liner with tabs welded on a backside of the separate interior liner so that either or both stamped and welded liners are heated and/or cooled as required and wherein a separate interior insulated liner insulates and moderates a temperate environment without use of a heater or cooler.

The instrument enclosures are provided wherein heating is achieved with heater cables, heating elements, finned heaters, printed circuit heaters, a heater hanger, wherein heat is provided via electrical wires, conduction and/or convection.

The instrument enclosures are provided wherein cooling is achieved by air conditioning, cooling fans, vortex tubes that are also a portion of a separate and attachable liner.

The instrument enclosures are provided wherein hinges between the top section casing and the bottom section casing along first edges of the top section casing and the bottom section casing includes additional hinging between top casing and bottom casing sections that provides multiple variations of open and closed configurations of the instrument enclosures wherein the additional hinging includes fixed and/or detachable hinging between any of second, third, and fourth edges.

The instrument enclosures are provided, wherein a first part of the bottom section casing possesses a first notch; a second part of the bottom section casing possesses a second notch; and wherein the first notch and the second notch are configured to define an opening in the bottom section casing.

The instrument enclosures, wherein an opening in the bottom section casing is configured to accept and connect with a standpipe and wherein the standpipe is attached to the bottom section casing and/or resides within an instrument enclosure.

The instrument enclosures are provided, wherein:
one or more interior surfaces of the bottom section casing includes one or more instrument attachment elements that allow for attachment to, removal of, and/or rotation for a field instrument to the bottom section casing; and
wherein the enclosed space exists to receive one or more field instruments removably attached to the bottom section casing.

The instrument enclosures, wherein an opening in the bottom section casing is configured to receive one or more process line conduits that convey one or more measurable process parameters to the one or more field instruments.

The instrument enclosures, wherein: the one or more process line conduits are enclosed in-process line tubing; and the opening in the bottom section casing is configured to engage the process line tubing.

The instrument enclosures, wherein:
a first portion of the bottom section casing defines a first pipe notch and a first line notch;
and a second portion of the bottom section casing defines a second pipe notch and a second line notch such that the first pipe notch and the second pipe notch are configured to define a standpipe opening in the bottom section casing such that the standpipe opening is configured to engage the standpipe; and wherein the first line notch and the second line notch are configured to define a process line opening in the bottom section casing;
wherein the process line opening is configured to receive process line tubing enclosing one or more process line signals conveying one or more process line parameters to the one or more field instruments.

The instrument enclosures, wherein: the bottom section casing is configured to be fastened to bracket affixed to the standpipe;
wherein the bracket includes a plurality of openings suitable for receiving fasteners; and wherein,
the bottom section casing includes a plurality of openings corresponding to the plurality of openings in the bracket.

The instrument enclosures, wherein, the instrument enclosures comprise a convex polyhedral instrument enclosure.

The instrument enclosures, wherein the convex polyhedral instrument enclosures comprise a hexahedral instrument enclosure comprising six planar surfaces including an upper surface, a lower surface, a forward surface, a rearward surface, a left surface, and a right surface.

The instrument enclosures, wherein:
the top section casing includes an upper surface, a forward surface, a first portion of a left surface, and a first portion of a right surface; and the bottom section casing includes a lower surface, a rearward surface, a second portion of a left surface, and a second portion of a right surface.

The instrument enclosures, wherein:
the first part of the bottom section casing includes a first portion of the lower surface, a first portion of the rearward surface, and the second portion of the left surface; and a second part of the bottom section casing includes a second portion of the lower surface, a second portion of the rearward surface, and a second portion of the right surface.

The instrument enclosures, wherein the first portion of the lower surface comprises a first half portion of the lower surface; the second portion of the lower surface comprises a second half portion of the lower surface the first portion of the rearward surface comprises a first half or the rearward surface and the second portion of the rearward surface comprises a second half of the rearward surface.

The instrument enclosures, wherein at least one planar surface of the instrument enclosures contains one or more windows that are transparent and exhibit durability that minimize or eliminate breakage of the windows.

The windows, wherein the windows are composed of tempered glass.

A method of providing one or more instrument enclosures that enclose and protect and keep one or more field instruments at a desired location within a moderate temperate climate, the method comprising:
hinging a hinged section of an instrument enclosure to a vertical support section that is self-standing and/or secured to stand vertically, including a standpipe, located in the desired location wherein the hinging enables the hinged section to rotate relative to the vertical support section between a closed position and one or more open positions of the instrument enclosures such that one or more instruments mounted within the one or more instrument enclosures are also capable of rotation or other position adjustments and wherein a combination of the vertical support section and the hinged section, in a closed position defines an enclosed space that is dimensioned to receive the one or more field instruments and wherein the one or more instrument disclosures are constructed in order to provide a protective barrier a separate partitioned and interchangeable parts insulated liner is constructed that can be either heated or cooled if needed and exists between an enclosed space and an external environment wherein the instrument enclosures are located such that protective barrier shields and moderated temperatures of the enclosed space from one or more environmental elements;
and;
affixing the one or more field instruments to one or more supporting structures wherein the field instruments are disposed in a desired, particular position within the enclosed space such that the instrument enclosure is attached to the vertical support section wherein the hinged section is hinged to the vertical support section and the instrument enclosures are enclosed within a closed portion of the instrument enclosures.

The method, wherein a sequence of performing the hinging, the attaching, and the supporting includes a sequence selected from the group consisting of:
hinging, attaching, and supporting; attaching, hinging, and
supporting; supporting, hinging, and attaching; and
supporting, attaching, and attaching.

The method, further comprising: forming the fixed section by fastening a first part of the hinged section to a second part of the hinged section.

The method, wherein supporting field instruments comprise performing an operation to provide support from the group consisting of:
attaching the field instruments to the vertical support structure, wherein the instrument enclosure defines an aperture configured to receive a terminal portion of the vertical support structure; allowing for rotation and/or other positioning of the field instruments within the instrument enclosures and attaching the field instruments to one or more attachment features of the instrument enclosure.

An adjustable assembly comprising; at least one enclosure portion that provides an internal or external housing of one or more instruments with an insulating housing that includes individual interchangeable parts that provide a portion of or completed separate attachable interior liner and exterior cap for the internal or external housing and one or more heater elements that are enclosed by at least one main heater or one main cooler body assembly wherein the main heater and cooler body assemblies includes at least one or more hooked projections wherein the hooked projections are shaped in an inverted L-shaped arrangement and wherein the hooked projections are attached to at least one lateral or at least one medial or both lateral and medial sides of a center portion of the main heater body assembly and wherein the finned heater body includes one or more positional openings that allow for containment of the heater element and concurrently provide a spatial geometric arrangement so that the one or more hooked projections provide an ability for the finned heater body and the internal or external housing of one or more instruments to be hung in adjustable manner from a mounting bracket that is attached to a post or pipe stand.

The adjustable assembly, wherein the mounting bracket attached to the post or pipe stand comprises two semi-circumferential left and right mounting bracket sections that can be mated, wherein each section is contoured to fit around the pipe stand and is secured tightly to the pipe stand.

The adjustable assembly, wherein the pipe stand is provided with an adjustable or non-adjustable pipe stand clamp so that the enclosure assembly and the mounting bracket can be located at an optimal location and/or height along a length of the pipe stand.

The adjustable assembly, wherein the finned heater body is an assembly that also includes hooked projections that extend from a center portion of the finned heater body to provide an ability for the finned heater body to be hung from the mounting bracket by utilization of inverted L-shaped hooked projections.

The adjustable assembly, wherein the two semi-circumferential mounting bracket sections provides a U-shaped body that is contoured in order to provide a geometric fit and attachment to the pipe stand.

The adjustable assembly, wherein the two semi-circumferential mounting bracket sections are secured to the pipe stand with a tensioning fastener that allows for adjustable pinning and tightening of the two mated semi-circumferential mounting brackets to the pipe stand.

The adjustable assembly, wherein an engagement lip is created that surrounds the U-shaped body so that the finned heater body can be hung anywhere along a 360-degree perimeter of the engagement lip and wherein the engagement lip is completed after the two mated semi-circumferential mounting bracket sections are mated.

The adjustable assembly, wherein the two semi-circumferential mounting bracket sections with the U-shaped body have an inner contour portion on each of two semi-circumferential halves and an outer contour portion located on an outside portion of the U-shaped body, wherein the outer contour portion is located in a position further way from the pipe stand such that an offset from the inner contour portion of the two mated semi-circumferential mounting bracket sections creates at least a portion of the engagement lip to enable the engagement lip to complete a 360-degree circumference around two semi-circumferential mounting bracket sections.

The adjustable assembly, wherein one or more instruments are also mounted by an attachment to two circumferential instrument mounting brackets with two halves that are shaped with a contour so that the that two circumferential instrument mounting brackets can be mated and attached to the pipe stand via a tensioning fastener.

The adjustable assembly, wherein both the one or more instruments and the one or more heater elements are mounted either within or external to one or more enclosure portions and wherein one or more heater elements are enclosed by at least one main heater body assembly surrounded by and attached to heat transfer fins to provide a finned heater body and wherein two or more mounting brackets secure both the one or more instruments and one or more heater body assemblies to the pipe stand and wherein attachment to an existing mounting can either be added or removed without dismantling other portions of the field mountable instrument heater.

The adjustable assembly, wherein at least two semi-circumferential left and right mounting bracket sections that can be mated can also be rectangular or in another shape configured to secure the one or more instruments and one or more heater elements to the pipe stand.

The adjustable assembly wherein the tensioning fasteners are selected from at least one of a group consisting of clamps, braces, grips, vices, clips, screws, and bolts.

A field mountable instrument heater comprising; at least three components that fit together in at least one adjustable configuration, wherein the at least three components include two components that are adjustable to accommodate and attach to a pipe stand or mounting post and wherein a third component is a housing with an insulating housing that includes individual interchangeable parts that provide a portion of or completed separate attachable interior liner and exterior cap for the internal or external housing and one or more heater elements that are enclosed by at least one main heater or one main cooler body assembly wherein the main heater and cooler body assemblies includes at least one or more hooked projections wherein the hooked projections are shaped in an inverted L-shaped arrangement and wherein the hooked projections are attached to at least one lateral or at least one medial or both lateral and medial sides of a center portion of the main heater body assembly and wherein the finned heater body includes one or more positional openings that allow for containment of the heater element and concurrently provide a spatial geometric arrangement so that the one or more hooked projections provide an ability for the finned heater body and the internal or external housing of one or more instruments to be hung in adjustable manner from a mounting bracket that is attached to a post or pipe stand.

A method for installing and using an adjustable assembly comprising; at least one enclosure portion that provides an internal or external housing of one or more instruments and one or more heater elements that are enclosed by at least one main heater body assembly surrounded by and attached to heat transfer fins to provide a finned heater body wherein the main heater body assembly includes at least one or more hooked projections wherein the hooked projections are shaped in an inverted L-shaped arrangement and wherein the hooked projections are attached to at least one lateral or at least one medial or both lateral and medial sides of a center portion of the main heater body assembly and wherein the finned heater body includes one or more positional openings that allow for containment of the heater element and concurrently provide a spatial geometric arrangement so that the one or more hooked projections provide an ability for the finned heater body and the internal or external housing of one or more instruments to be hung in adjustable manner from a mounting bracket that is attached to a post or pipe stand, wherein the method allows for removing, adding, installing, and using instruments in a controlled and regulated either heated or unheated environment without requiring any disassembly and/or reassembly of any items along the pole stand.

The method, wherein the mounting bracket attached to the post or pipe stand comprises two semi-circumferential left and right mounting bracket sections that can be mated, wherein each section is contoured to fit around the pipe stand and is secured tightly to the pipe stand.

The method, wherein the pipe stand is provided with an adjustable or non-adjustable pipe stand clamp so that the enclosure assembly and the mounting bracket can be located at an optimal location and/or height along a length of the pipe stand.

The method, wherein the finned heater body is an assembly that also includes hooked projections that extend from a center portion of the finned heater body to provide an ability for the finned heater body to be hung from the mounting bracket by utilization of inverted L-shaped hooked projections.

The method, wherein the two semi-circumferential mounting bracket sections provides a U-shaped body that is contoured in order to provide a geometric fit and attachment to the pipe stand.

The method, wherein the two semi-circumferential mounting bracket sections are secured to the pipe stand with a tensioning fastener that allows for adjustable pinning and tightening of the two mated semi-circumferential mounting brackets to the pipe stand.

The method, wherein an engagement lip is created that surrounds the U-shaped body so that the finned heater body can be hung anywhere along a 360-degree perimeter of the engagement lip and wherein the engagement lip is completed after the two mated semi-circumferential mounting bracket sections are mated.

The method, wherein the two semi-circumferential mounting bracket sections with the U-shaped body have an inner contour portion on each of two semi-circumferential halves and an outer contour portion located on an outside portion of the U-shaped body, wherein the outer contour portion is located in a position further way from the pipe stand such that an offset from the inner contour portion of the two mated semi-circumferential mounting bracket sections creates at least a portion of the engagement lip to enable the engagement lip to complete a 360-degree circumference around two semi-circumferential mounting bracket sections.

The method, wherein one or more instruments are also mounted by an attachment to two circumferential instrument mounting brackets with two halves that are shaped with a contour so that the that two circumferential instrument mounting brackets can be mated and attached to the pipe stand via a tensioning fastener.

The method, wherein both the one or more instruments and the one or more heater elements are mounted either within or external to one or more enclosure portions and wherein one or more heater elements are enclosed by at least one main heater body assembly surrounded by and attached to heat transfer fins to provide a finned heater body and wherein two or more mounting brackets secure both the one or more instruments and one or more heater body assemblies to the pipe stand.

The method, wherein at least two semi-circumferential left and right mounting bracket sections that can be mated can also be rectangular or in another shape configured to secure the one or more instruments and one or more heater elements to the pipe stand.

The method, wherein the tensioning fasteners are selected from at least one of a group consisting of clamps, braces, grips, vices, clips, screws and bolts.

The instrument enclosure herein addresses problems that may arise with heaters used for insulated heated enclosures presently employed. With respect to rigid-type enclosures, the thermally controlled instrument enclosure provides the following non-exhaustive list of advantages:
Allows for the heater in the instrument enclosure to be mounted in such a way that it is integrated into the insulation system, and out of the way of taking up any space inside of the working area of the enclosure, beneficially removing the large finned heaters and block heaters used today, as well as removing the necessary conduit and conduit junction boxes which take up even more space of the already tight enclosure interior.
Enables contractors to improve their productivity during original installation by eliminating the practice of providing and installing conduits, conduit junction boxes and the threading machines and added equipment needed to install such conduits to provide power to these traditional finned and or block style heaters. The labor required to run secondary power distribution such as the conduit and other conduit equipment pieces to mount traditional finned and block heaters is extremely expensive and very time-consuming work.
Saves time during original installation because disclosed heater liner and insulation system comes preassembled, with only the heater cable terminations needing to be made to the Multi-Point Power Connection box located just below the instrument on the pipe stand.
Provides far superior watts output as compared to finned and block heaters. The engineered 40 ft of cable (20 ft on the top section and 20 ft on the bottom section) will allow for up to 800 watts of heat, which the maximum size Finned heater that can currently fit inside of an enclosure is 400 watts. The heater liner would double the heat output while still removing the large heater and conduits from the inside real estate of the enclosure.
Utilizes heater cables that come certified for hazardous areas with Auto Ignition Temperature ratings as low as T6 and as high as T2, providing a much more complete range of temperatures in which the disclosed lined heater can operate.
Utilizes heater cables that come in a myriad of output ranges, depending on the manufacturer which allows the lined heater system to produce from 120 watts of output up to 800 watts of output. Even higher outputs are possible by adding more heater cable to the liner if needed.
Utilizes heater cables that are built to last 30+years in service. Whereas the traditional finned and block style heaters used today often fail in less than 5 years, leaving critical instrumentation at risk, which often shuts down power plants and other critical infrastructure.
The Liner heater will save time and money in original installations and re-installations after maintenance with a simple replacement of the heater cables on the liner providing a much more friendly system to maintain.
The Liner heater can also be used for heating analyzer shelters, and other enclosed spaces for the industrial and non-industrial processing facilities.

### BRIEF DESCRIPTION OF THE DRAWINGS

FIG. 1 provides a partially exploded isometric view of the bottom assembly of a thermally controlled instrument enclosure assembly utilizing a drawn customizable heated liner system from a top side perspective;

FIG. 1A illustrates a right-side portion of a partially assembled drawn customizable heater liner system.

FIG. 1B provides a surface view of the drawn liner forming the internal housing surface of the instrument enclosure.

FIG. 1C illustrates a left-side portion of a partially assembled drawn customizable heater liner system including a bottom insulation liner portion.

FIG. 2 illustrates a partial bottom assembly of the thermally controlled instrument enclosure assembly utilizing a stamped customizable heated liner system from a top side perspective;

FIG. 2A provides an elevated side-view of a portion of a partially assembled stamped customizable heater liner system.

FIG. 2B provides a bottom view of a portion of a partially assembled stamped customizable heater liner system.

FIG. 3 provides a cross-sectional view of right bottom casing segment of a thermally controlled instrument enclosure utilizing a customizable heater liner system, either drawn or stamped;

FIG. 3A illustrates a cross-section of a left-side portion of a partially assembled customizable heater liner system including a bottom insulation liner portion.

FIG. 4 provides a partially exploded isometric view of the top casing of a thermally controlled instrument enclosure utilizing a customizable drawn heater liner assembly from a top side perspective;

FIG. 4A illustrates the drawn liner having separate welded tabs for heater cable attachment.

FIG. 4B illustrates the drawn liner utilizing separate welded tabs for heater cable attachment.

FIG. 5 provides a partially exploded isometric view of the top casing of a thermally controlled instrument enclosure utilizing a customizable stamped heater liner assembly from a top side perspective;

FIG. 5A provides a surface view of the interior liner cover forming the internal housing surface of the instrument enclosure.

FIG. 5B illustrates the stamped liner having cut and bent tabs for heater cable attachment.

FIG. 5C illustrates the stamped liner utilizing cut and bent tabs for heater cable attachment.

FIG. 5D illustrates an interior view of the stamped liner with mounting tabs.

FIG. 5E provides a partially assembled top casing utilizing a stamped liner mounted to the interior liner cover.

FIG. 5F provides a close-up of a partially assembled top casing utilizing a liner system mounted to the interior liner cover and top casing having front latches.

FIG. 5G provides a close-up of a partially assembled top casing utilizing a liner system mounted to the interior liner cover and top casing having rear hinges.

FIG. 6 provides a cutaway illustration of the stamped heater liner system of the top casing, showing the fitting of each liner system component through the last interior edge(s).

FIG. 7 provides an illustration of the drawn heater liner system of the top casing, showing the fitment of each liner system component.

FIG. 8 illustrates a complete assembly of the instrument enclosure in which the instrument enclosure is attached to a mounting plate affixed to a standpipe or other suitable standing structure.

FIG. 8A depicts the edges of the top and bottom casings, connected by a hinge, that when in a closed configuration allow physical contact of the edges in order to provide a sealed enclosure.

FIG. 8B illustrates the cross-section of a complete assembly of the instrument enclosure in which the instrument enclosure is attached to a mounting plate affixed to a standpipe or other suitable standing structure.

FIGS. 9 and 9A illustrate a complete assembly of the instrument enclosure in which multiple field instruments are utilized;

The figures and corresponding text disclose non-limiting examples and embodiments. Reference numerals used in different figures represent similar structures or procedures unless denoted otherwise. Features shown may be enlarged or reduced relative to other features for clarity or emphasis to ensure better understanding.

### DETAILED DESCRIPTION

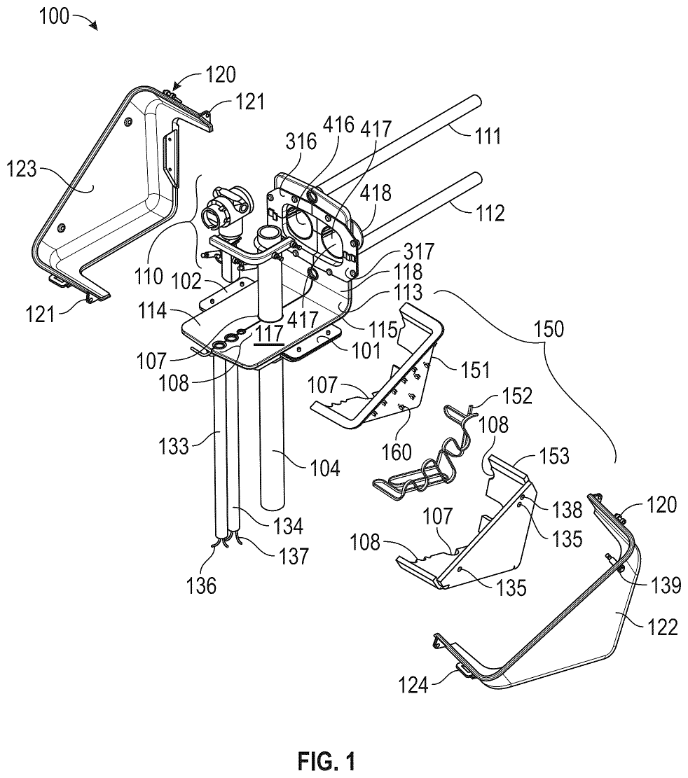

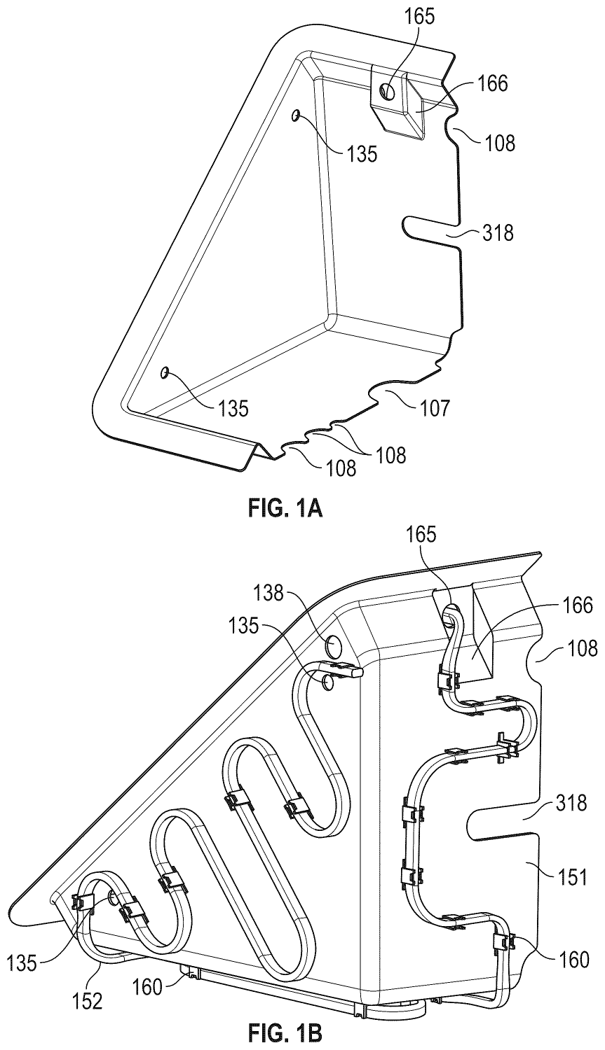

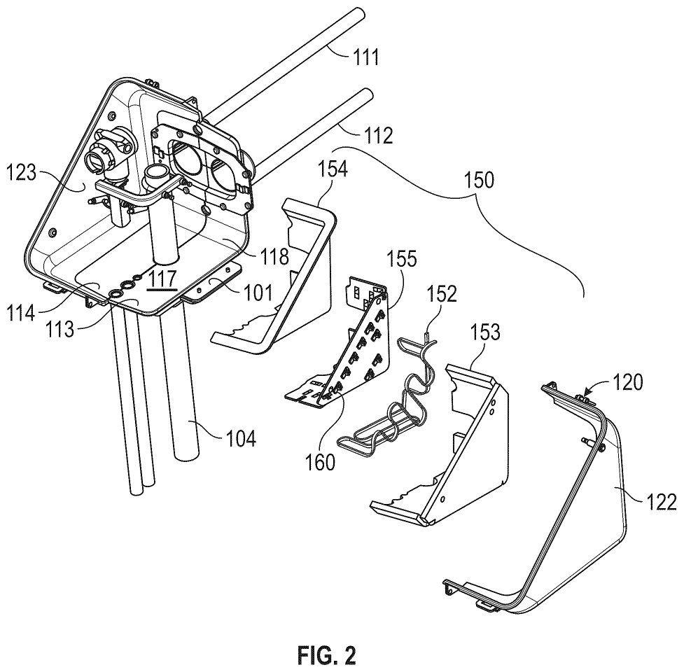

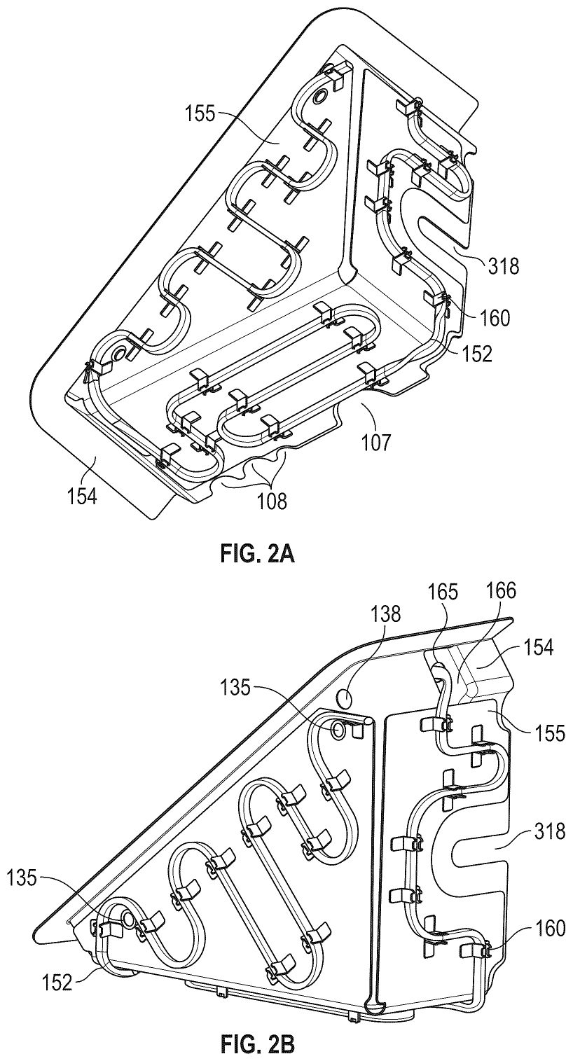

As illustrated in FIG. 1 and FIG. 2, a thermally controlled instrument enclosure utilizing a customizable heater liner system [150], herein “instrument enclosure”, includes left and right mounting plate sections [101,102] which when joined create a mounting plate affixed to a standpipe or other suitable standing structure onto which the thermally controlled instrument enclosure mounts. The mounting plate sections [101,102] may be made of metal or other suitable material(s). The left and right mounting plate sections [101, 102] are identical.

A field instrument can be directly mounted, affixed, or otherwise attached to the standpipe or other suitable standing structure that limits contact of the instrument with the instrument enclosure [100]. The mounting plate sections [101,102], when completed, provide support to the instrument enclosure separately and apart from the support of the field instrument [110].

In addition, the illustrated field instrument is attached to process line tubing [111,112] configured to provide a process flow, as well as measurable parameters, to the field instrument [110]. The illustrated instrument enclosure includes a rigid or semi-rigid instrument enclosure configured to be attached to standpipe or completed mounting plate sections [101,102] such that the instrument enclosure encompasses field instrument while permitting ingress/egress for the process line tubing [111,112].

In one embodiment, field instruments having similar operating requirements can be used in tandem allowing more than one field instrument to be included within the instrument enclosure [100].

In a further embodiment, the arched recess can be provided in any suitable shape that can accommodate a suitable standing structure other than a standpipe having a cylindrical shape. These arched recesses may be shaped in accordance with the shape of the standpipe [104]. For the circular embodiment of the standpipe presented, each arched recess may define a semicircular arc.

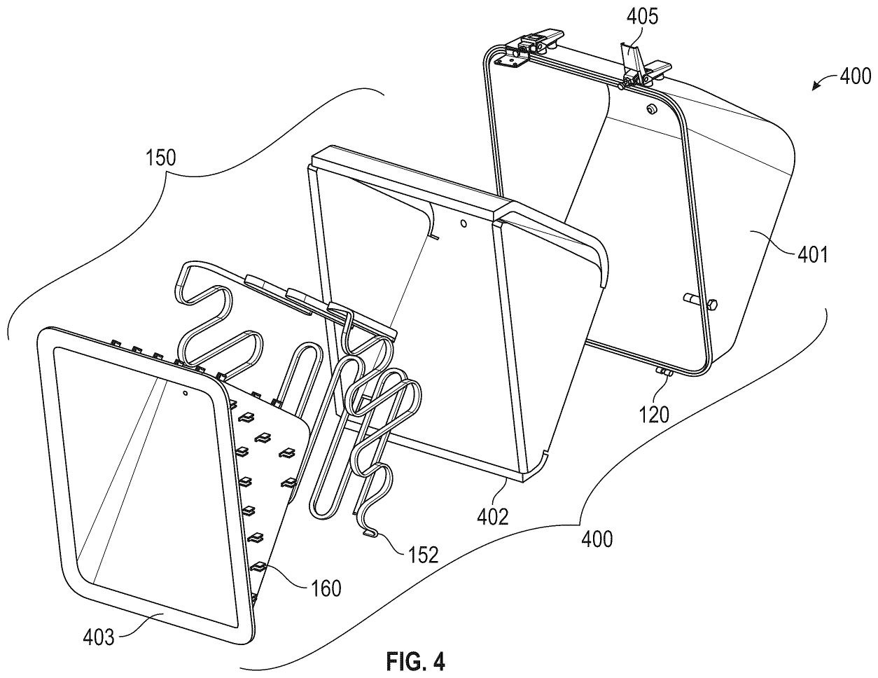

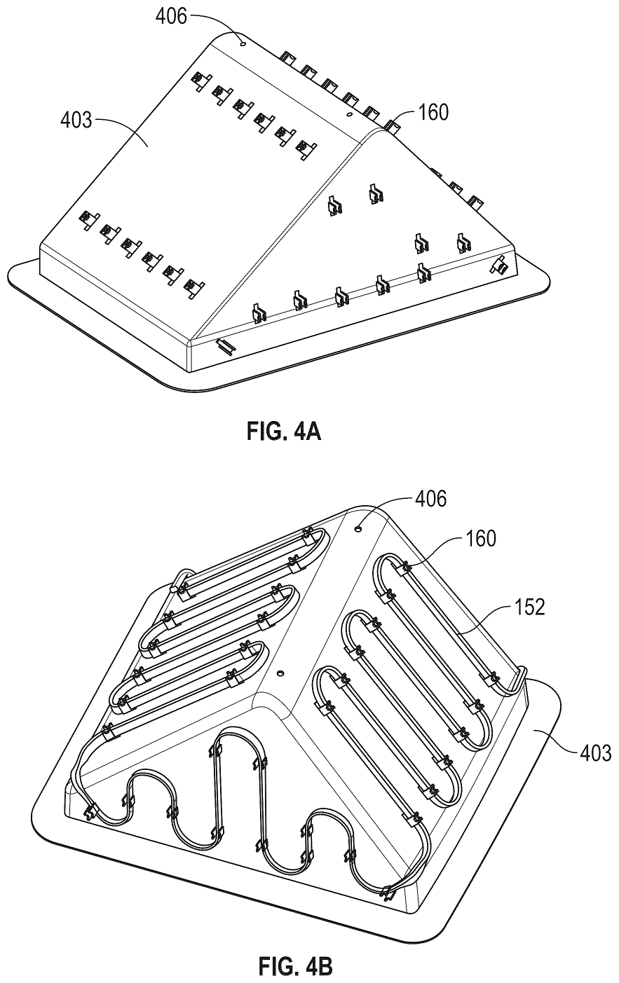

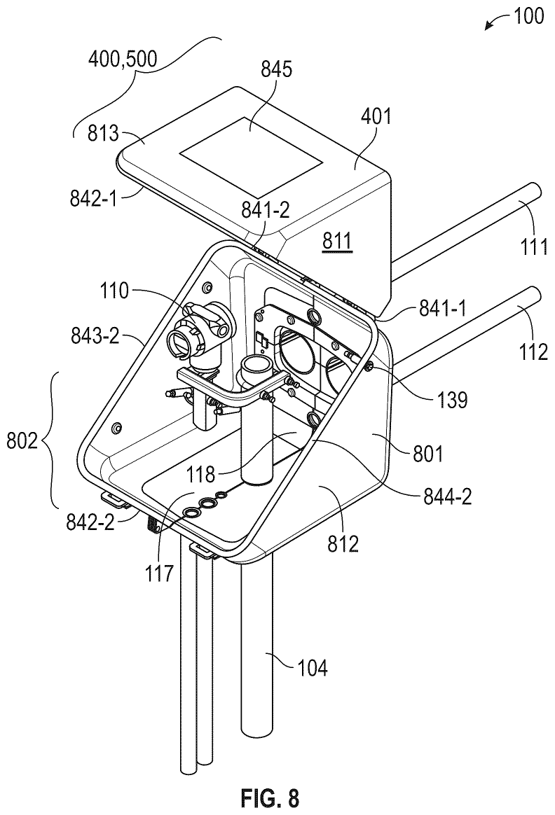

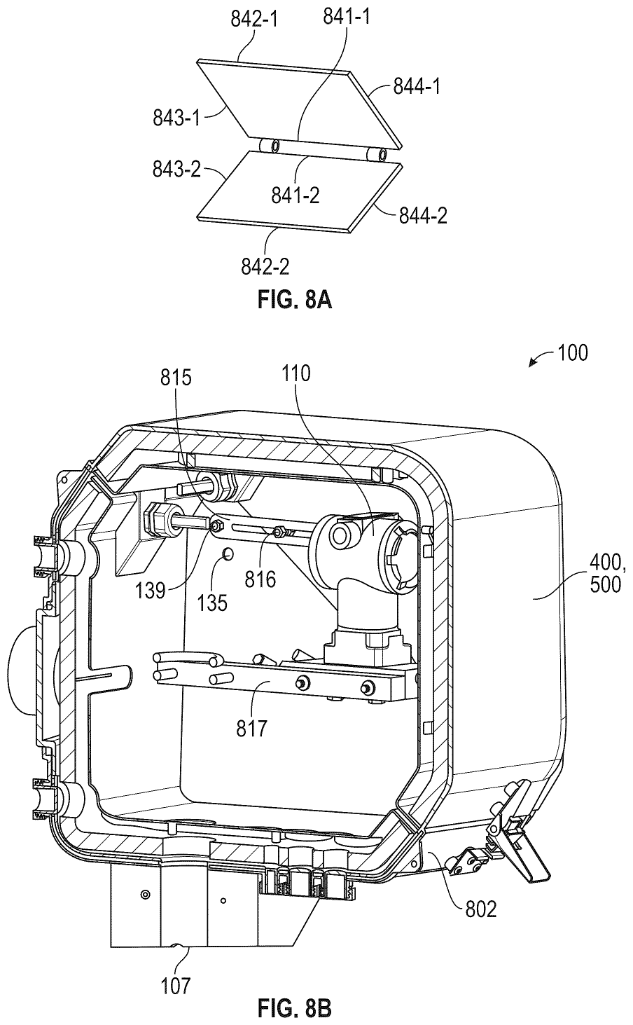

The left and right bottom base sections [113,114] are mirror images and therefore are arranged in a reverse configuration when compared to the other. The left bottom base section is distinct and detachable from the right bottom base section [114]. The bottom base sections [113,114] are connected together along respective L-shaped edges forming the bottom base [115]. Hinges [120] or other suitable attachments can be provided. Hinges may enable top casing [401, shown first in FIG. 4] to rotate between an open position as best shown in FIG. 8 and a closed position (first shown in FIG. 8B). A bottom latch component allows for the top casing to be secured to the left and right bottom casing [122,123]

The bottom base sections [113,114] are joined atop the joined mounting plate sections [101,102] where a portion of the left and right mounting plate sections [101,102] remain accessible under the bottom base for the mounting of the left and right bottom casing segments [122, 123]. FIG. 2 illustrates the attachment of the right bottom casing segment to the right bottom base section [114]. Flanges are provided as means of securing the left and right bottom casing [122,123] to each other with a fastener, not shown.

Each bottom base section [113,114] includes a lower planar portion and an upper planar portion that is perpendicular or substantially perpendicular to the lower planar portion [117].

As illustrated in the figures, the lower planar portions of the bottom base sections [113, 114] are oriented in a substantially horizontal plane while the perpendicular upper planar portions of the bottom base sections [113,114] are oriented in a substantially vertical plane. Each lower planar portion may include or define an arched recess configured to engage standpipe such that the two bottom base sections [113,114] may be attached to one another while engaging the standpipe [104].

Each upper planar portion may include or define a lipped recess having a lip configured to engage the top and bottom portal plates having dual concavity sections [318] that when joined form ingresses [416,417] (shown in FIG. 1) that can be used for additional portals for data collection and monitoring. A gasket or other suitable sealing means is fitted within the lip of the lipped recess of the upper planar portion to provide additional environmental isolation between the environment and enclosed space(s) defined when the instrument enclosure is in a closed configuration. The outward edges of the ingresses [416,417] of FIG. 1 are sealed with a transparent or translucent glass or plastic lens [418], that can be planar, convex, concave or otherwise shaped for optimization of the field instrument(s) enclosed within the instrument enclosure [100].

In further embodiments, the lenses can be made of any suitable material or combination of materials that allows for optimal function and data collection of the field instrument(s) within the instrument enclosure [100].

The top casing and complete bottom casing [802, which is consists of 113, 114, 122, 123] illustrated in FIG. 8, are substantially triangular in cross section as best illustrated by the substantially triangular side panel of top casing and the substantially triangular side panels of bottom casing [802]. A front panel of top casing is illustrated with an optional window to enable visual inspection of the thermally controlled instrument enclosure without opening the thermally controlled instrument enclosure [100]. A window [845] may be comprised of tempered glass or any other sufficiently transparent and durable material.

FIG. 1 more specifically illustrates the inner assembly of the lower portion of a thermally controlled instrument enclosure utilizing a customizable heater liner system where the lower liner is a drawn liner with strategically located heater cable routing tabs engineered to specific length and design and welded to the drawn liner [151], heat trace cables [152] and a bottom insulation liner [153]. The heat trace cable can be of various outputs, including at least 5 watt per foot, 10 watt per foot, 15 watt per foot, 20 watt per foot ranges, and the bottom insulation liner can be of varying type and thickness as needed by ambient climate demands.

The bottom insulation liner (and top insulation liner as shown in FIG. 4) is a molded foam such as urethane or polyisocyanurate with notches in place to allow the heater cable to nest into the foam as to sit as flush into the enclosure as possible. Insulation half shell sections comprising of notched insulation to nest the heater cable into the bottom section of the enclosure, are fitted within the complete bottom casing [802, which is consists of 113, 114, 122, 123] and engage the standpipe via arched recess and the tubing via notches [108]. The sections [151, 152, 153] completing the heated liner system are joined using openings [135] suitable for receiving fasteners, not shown. A sliding hinge aperture is provided to house the slider hinge fastener providing a support via sliding hinge [815, as shown in FIG. 8B] to the open configuration of the instrument enclosure [100].

FIG. 1A provides an interior surface view of the right bottom portion of the drawn liner showing the smooth internal metal surface capable of fitment within the instrument enclosure to a mirror-image left side drawn liner [151]. Fitment features of the drawn liner include the arched recess [107], notches and dual concavity section [318], while fastening features include the openings [135]. The heater cable aperture within the cable guard provides protection to the heat trace cable [152, not shown].

FIG. 1B depicts the heat trace cable routed, for maximum coverage of the instrument enclosure, through the welded heater cable routing tabs of the drawn liner [151] component of the heated liner of the bottom casing [122, 123]. The heat trace cable [152] enters the internal space of the instrument enclosure through the heater cable aperture [165]. The heater cable aperture is located at the internal terminus of a moldable and drawable raised bump feature designed as a cable exit to the heat trace cable [152]. The cable exit of the bottom casing [122,123] is positioned at the top rear of the drawn liner allowing the heat trace cable to remain in an optimal position for reduced interference with components of the enclosure and accidental interaction with the operator or maintenance personnel.

FIG. 2 more specifically illustrates the inner assembly of the lower portion of a thermally controlled instrument enclosure utilizing a customizable heater liner system [150], where the lower liner includes an interior liner cover [154], a stamped liner with strategically located heater cable routing tabs engineered to specific length and design and stamped from the single piece of sheet metal of the stamped liner [155], heat trace cables and a bottom insulation liner [153]. The drawn liner system does not use an interior liner cover, as the drawn liner acts as the liner cover while also housing the heat trace cable [152].

Heat trace cables used with the customizable heated liner system employ a wider range of hazardous approvals, such as a range of Temperature Class ratings (also T-Class or T-ratings). Most block heaters are limited to a T3 (392° F. hazardous rating) whereas the heat trace cables used with the heated liner system will have ratings that range from T6, T5, T4, T3, T2, T1 for hazardous locations.

The heat trace cable is located on the underside of the drawn liner and sandwiched with a bottom insulation liner which can be from various insulation types such as pyrogel, fiberglass, urethane and polyisocyanurate. Most other instrument enclosure manufacturers bond their insulation into the enclosure, limiting the ability to utilize a heated liner system as provided. It would be very difficult to add the heat trace cable onto existing insulation systems, and even if successful, additional space would be taken up inside of the instrument enclosures where space is already limited.

On the back side of the drawn liner [151], there are heater cable routing tabs [160]. These clips or tabs can either be welded onto the drawn liner or stamped out of the stamped liner (as shown in FIG. 2) to perfectly position the heat trace cable in a channel that holds the cable tightly against the liner [151 or 154] to provide a very uniform heat convection system stopping heat loss to ambient conditions. Heat trace cables are fed into the thermally controlled instrument enclosure via the standpipe through an exterior cable access port equivalent to a port cut into the standpipe on the exterior of the enclosure, wherein the heat trace cable will be terminated into a multi-point power connection box which is not shown and can include a thermostat that controls heating or cooling as required. The heat trace cables will enter the instrument enclosure via another interior cable access port, also not shown, which is provided in the standpipe on the interior section of the instrument enclosure [100].

Likewise, by utilizing the standpipe to route the heat trace cable [152], the heat trace cable will additionally be providing much needed heat to eliminate the standpipe from pulling excessive heat out of the heated inside condition.

Once the heat trace cable exits the internal cable access port (not shown) of the standpipe [104] on the inside of the instrument enclosure [100], it are routed into the heater cable aperture [105] located on the heater cable exit [166]. An optional conduit made of irradiated polyvinylidene fluoride (PVDF) or another suitable material for heater cables can be used in place of or in conjunction with the heater cable exit [166]. An example conduit is Convolex, made by Raychem. The heater cable exit or optional conduit serves two purposes:
1). protecting the heater cable, and
2). keeping the electrically charged heater cable from being easily accessed by an operator who may be working on the enclosures.

The heat trace cable inside of the instrument enclosure goes from the standpipe into the liner [151,154], fed through a heater cable aperture located at the terminus of the cable exit [106]. The heater cable exit protects the heat trace cable from being cut by the liner's edge from movement caused by opening and closing of the instrument enclosure top casing. Additionally, the heater cables are out of touch to operators working on the instruments.

FIG. 2A provides a rear surface bottom view of the right bottom portion of the stamped liner capable of fitment onto the interior liner cover [154]. The stamped liner system provides fitment within the instrument enclosure to a mirror-image left side stamped liner [151]. Fitment features of the stamped liner include the arched recess [107], notches and dual concavity section [318], while fastening features include the openings [135].

FIG. 2B depicts the heat trace cables routed, for maximum coverage of the instrument enclosure, through the heater cable routing tabs of the stamped liner component of the heated liner of the bottom casing [122,123]. The heat trace cable enters the internal space of the instrument enclosure through the heater cable aperture [165]. The heater cable aperture is located at the internal terminus of a moldable and drawable raised bump feature of the interior liner cover designed as a cable exit to the heat trace cable [152]. The cable exit of the bottom casing [122,123] is positioned at the top rear of the drawn liner [151] allowing the heat trace cable to remain in an optimal position for reduced interference with components of the enclosure and accidental interaction with the operator or maintenance personnel.

A cable gland entry was used to transition heating cables into a junction box when making power, splice, or tec connections, such as a Raychem C-75-100a heating cable gland entry (not shown in this figure) The heating cable gland entry has a gland that protects the heater cable [152] from being cut by the liner's edge from movement caused by opening and closing of the instrument enclosure top casing. Additionally, the heater cables are out of touch to operators working on the instruments. The use of the cable exit replaces the use of the cable gland entry; however, the cable gland can still be used as an replacement option or in conjunction with the cable exit [106].

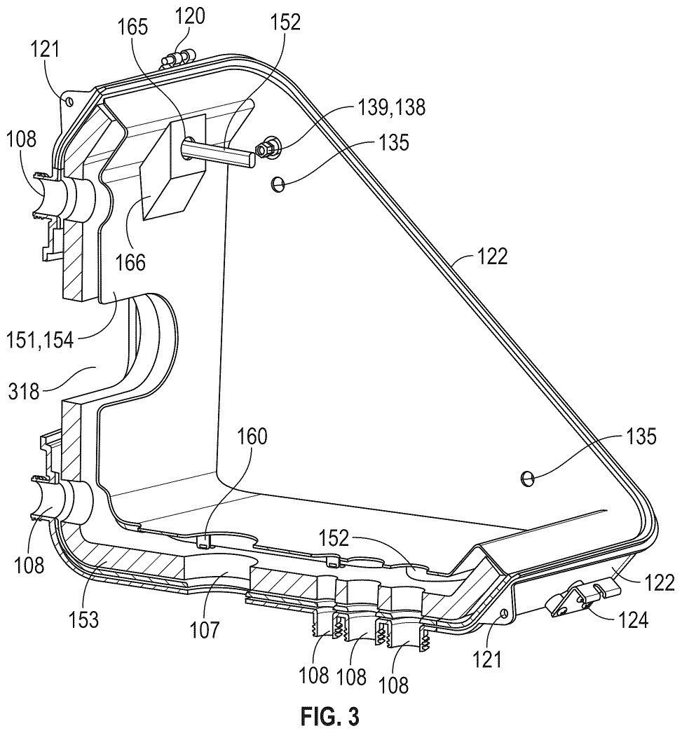

FIG. 3 provides a cross-sectional view of the left bottom casing segment of a thermally controlled instrument enclosure utilizing a customizable heater liner system [150], in either a drawn or stamped liner option. Differences in the inclusion of the stamped or drawn liner selection are not externally apparent when assembled as shown. In the case of the drawn heated liner system [150], the drawn liner [151], having a heater cable aperture within a bottom heater cable exit [166], is shown in combination with the heat trace cables [160], bottom insulation liner and left bottom casing [122]. he cross-section provides increased detail of the arched recess configured to engage standpipe [104, not shown] and notches configured to engage tubing [133, 134, not shown]. Openings are provided for securing together the components of the heated liner system [150], while hinges [120], flanges and bottom latch components [124] are provided for securing the instrument enclosure. A sliding hinge aperture is provided to house the slider hinge fastener providing a support via sliding hinge [815, as shown in FIG. 8B] to the open configuration of the instrument enclosure [100].

FIG. 4 provides a partially exploded isometric view of the top casing of a thermally controlled instrument enclosure utilizing a customizable drawn heated liner top assembly [400] from a top side perspective. The heater liner assembly of the drawn heated liner top assembly is completed using the top casing [401], top insulation liner [402], heat trace cable and the drawn top liner having welded heater cable routing tabs [160]. A latching mechanism is provided as a means of securing the top casing to the left and right bottom casing [122,123].

FIG. 4A and FIG. 4B provide the drawn top liner showing the heat trace cable and the heater cable routing tabs welded to the drawn top liner positioned at an engineered length and spacing to provide heating over a much larger area. Liner apertures are included for affixing the drawn top liner to the top insulation liner and the top casing [401].

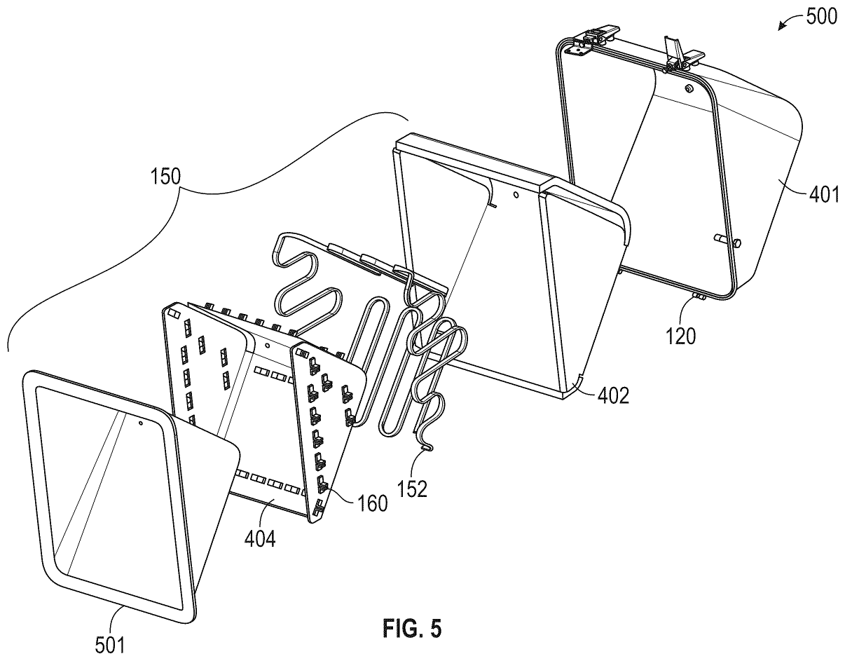

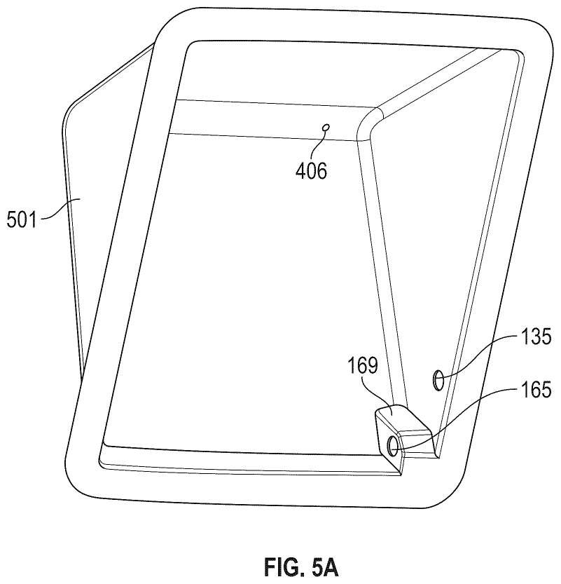

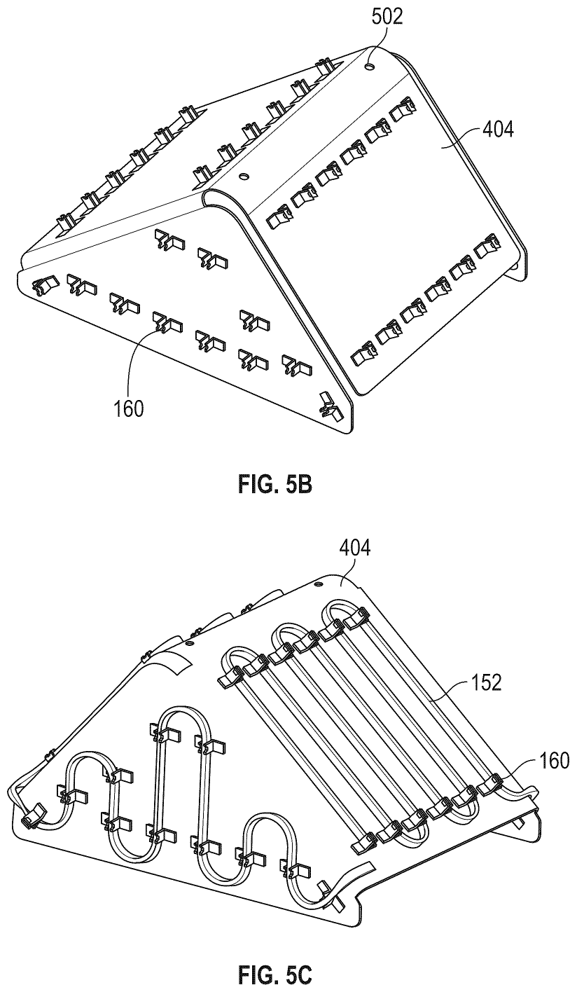

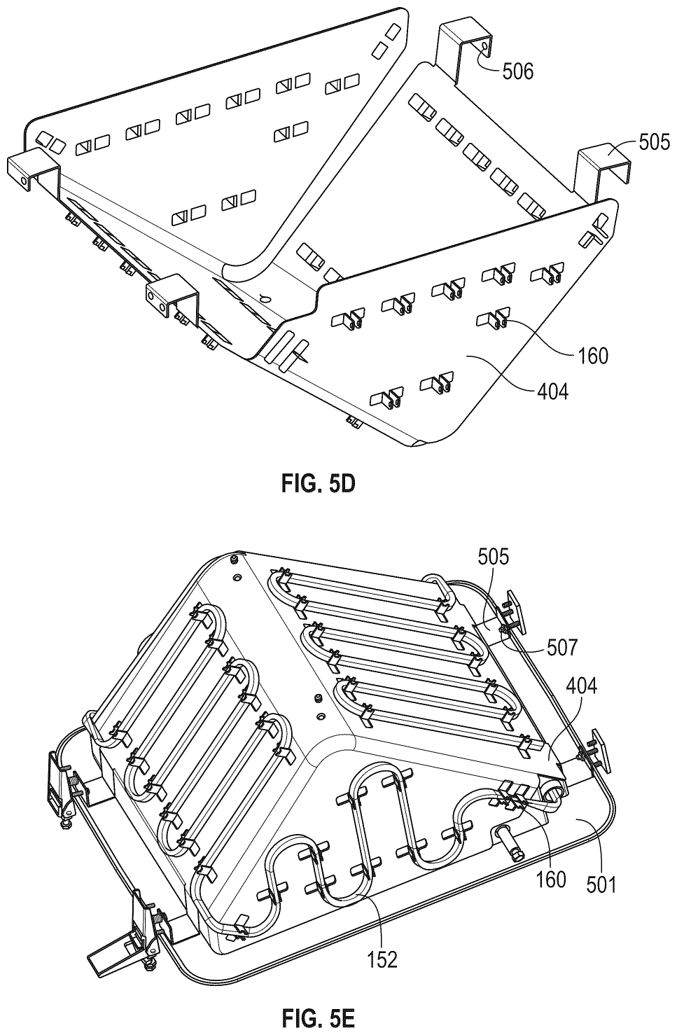

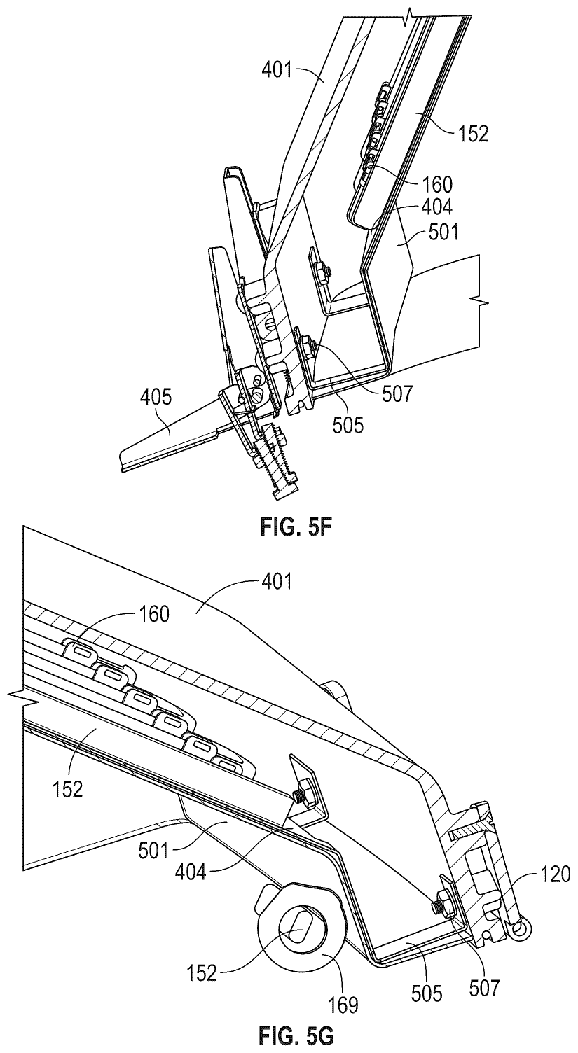

FIG. 5 provides a partially exploded isometric view of the top casing of a thermally controlled instrument enclosure utilizing a customizable heater liner assembly using a stamped top liner from a top side perspective. The heater liner assembly of the stamped heated liner top assembly is completed using the top casing [401], top insulation liner [402], heat trace cable [152], the stamped top liner with stamped heater cable routing tabs [160] and the top interior liner cover [501]. A latching mechanism is provided as a means of securing the top casing to the left and right bottom casing [122,123]. Liner apertures [406] are included for affixing the top interior liner cover to the stamped top liner to the top insulation liner and the top casing [401]. The stamped top liner is additionally affixed to the top interior liner cover using stamped liner apertures [502].

FIG. 5A provides an interior surface view of the top interior liner cover showing the smooth internal plastic surface capable of fitment within the top casing of the instrument enclosure. Fastening features include the openings and liner apertures [406]. The heater cable aperture [165] within the top heater cable exit provides protection to the heat trace cable [152, not shown]. The top heater cable exit is positioned at the bottom right corner of the top interior liner cover allowing the heat trace cable to remain in an optimal position for reduced interference with components of the enclosure and accidental interaction with the operator or maintenance personnel.

FIG. 5B and FIG. 5C depict the stamped top liner showing the heat trace cable [152], the heater cable tabs stamped out to create tabs or other mounting systems to add heat trace cable at an engineered length and spacing to provide heating over a much larger area, therefore eliminating cold spots that pull heat away from the thermally controlled instrument enclosure [100]. Stamped liner apertures are provided for fastening the stamped top liner [404] to the top interior liner cover [501].

The convection heating created by the heated liner system [150], in conjunction with the various insulation types will allow a very flexible design to meet temperature requirements from the most critical arctic conditions or any condition requiring the instrumentation mounted inside of an enclosure to be kept at a temperature above freezing.

FIG. 5D provides an underside view of the stamped top liner with liner mounting tabs [505]. The liner mounting tabs are used to secure the stamped top liner to the top casing using mounting tab apertures [506]. The mounting tabs are designed to have a wide J-hook feature to allow maximum widths of the bottom and top insulation liners [153, 402] while still allowing space for the mounting tab bolts [507], shown in FIG. 5E.

FIG. 5E illustrates a top view of the stamped top liner affixed to the top interior liner cover [501] using liner mounting tabs fastened with mounting tab bolts [507].

FIG. 5F illustrates a forward side cross-section stamped heated liner top assembly with the top insulation liner removed. Details of the latching mechanism are shown, behind which the liner mounting tabs of the stamped top liner are fastened using mounting tab bolts to the top casing [401]. Heat trace cables are shown routed through the heater cable routing tabs [160]. The top interior liner cover closes the remaining gap created by the liner mounting tabs [505], in which the top insulation liner resides, creating an adiabatic environment within the instrument enclosure [100], when the instrument enclosure [100] in in a closed position.

FIG. 5G illustrates a rearward side cross-section stamped heated liner top assembly with the top insulation liner removed. Details of the hinge are shown, behind which the liner mounting tabs of the stamped top liner are fastened using mounting tab bolts [507] to the top casing [401]. Heat trace cables are shown routed through the heater cable routing tabs [160]. The top interior liner cover closes the remaining gap created by the liner mounting tabs [505], in which the top insulation liner resides, creating an adiabatic environment within the instrument enclosure [100], when the instrument enclosure in in a closed position.

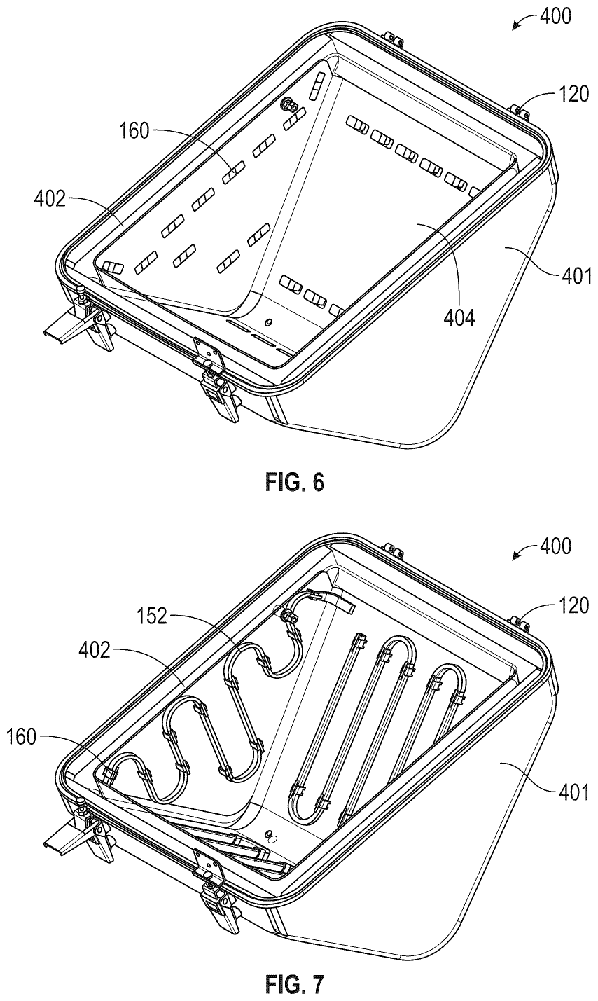

FIG. 6 and FIG. 7 provide cutaway illustrations of the top casing utilizing a heated liner system [150]. FIG. 6 provides a cutaway illustration of the stamped heater liner system of the top casing, showing the fitting of each liner system component through the last interior liner edge(s) in order to provide a completed view of a stamped heated liner top assembly [500]. The top interior liner cover is not shown in order to provide the cutaway view of the remaining components.

FIG. 7 provides a cutaway illustration of the drawn heater liner system of the top casing, showing the fitment of each liner system component through the last interior liner edge(s) in order to provide a completed view of a drawn heated liner top assembly [400]. The drawn top liner is shown as a transparent component in order to show the routing of the heat trace cable through the heater cable routing tabs in a manner that maximizes the surface area of the routed heat trace cable within the top casing of the instrument enclosure [100].

As best illustrated in FIG. 8, the thermally controlled instrument enclosure is in an open position, having a heated liner top assembly [400 or 500] including first, second, third, and fourth edges [841-1, 842-1, 843-1, and 844-1] of the top casing [401], and a complete heated liner bottom assembly including first, second, third, and fourth edges [841-2, 842-2, 843-2 and 844-2] of the bottom casing [801]. The heated liner bottom assembly is the completed construction of left and right bottom casing segments [122, 123] and the customizable heated liner system [150]. The first edge [841-2] of the bottom casing may be hinged or otherwise rotatably-affixed to the first edge [841-1] of the top casing via one or more hinges or other suitable attachment means, in which second, third, and fourth edges [842-1, 843-1, and 844-1], of top casing are in contact with or in close proximity to second, third, and fourth edges [842-2, 843-2 and 844-2] of bottom casing of the complete heated liner bottom assembly [802], as more thoroughly illustrated in FIG. 8A.

Although the figures illustrate hinging between the top casing sections and the bottom casing sections along first edges of the top casing sections and the bottom casing sections, embodiments of the instrument enclosure may include additional hinging between top casing and bottom casing sections to provide variations of open and closed configurations of instrument enclosures in addition to the open and closed configurations supported by the illustrated hinging. Such additional hinging may include, without limitation, fixed or detachable hinging between second edges [842], fixed or detach hinging between third edges [843], and fixed or detachable hinging between fourth edges [844].

In the closed position, the top casing [401] and bottom casing [801], utilizing a customizable heated liner system [150] cooperatively define a thermally controlled instrument enclosure space within which a field instrument may be located as described in more detail below. In at least some embodiments, top casing and bottom casing sections cooperatively form a cubic or substantially cubic thermally controlled instrument enclosure [100]. In at least some other embodiments, the top casing and bottom casing sections cooperatively form a rectangular cuboid or substantially rectangular cuboid thermally controlled instrument enclosure [100]. The components of the customizable heated liner system can be manufactured for fitment to any of the selected shapes or sizes of the top and bottom casing [401, 801]

The left and right bottom base sections [113,114] illustrated in FIG. 1 and FIG. 2 further include or define notches [108], configured to engage tubing and provide for enclosing power wires [136], and notches [108], configured to engage tubing that also encloses communication wires or fibers [137]. The upper planar portions define corresponding notches configured to engage process line tubing [111,112] such that the lower and upper planar portions [117,118] may be connected to each other while engaging process line tubing [111,112], allowing for process line tubing [111,112] to enter the instrument enclosure [100]. While the notches are illustrated in FIG. 1-FIG. 3 as smooth and continuous arcs, embodiments may incorporate grooves and/or other elements to better restrict or engage the applicable pipes, tubing, or other structural elements.

Gaskets or other types of sealing structures (not depicted) may be employed to provide additional environmental isolation between the environment and enclosed space defined when the instrument enclosure is closed.

The illustrated thermally controlled instrument enclosure utilizing a customizable heater liner system having a heated liner top assembly [400 or 500] and a heated liner bottom assembly is configured for independent attachment to the support and includes three mutually adjustable parts-top casing section, left bottom casing segment [122], and right bottom casing segment [123], that provide structure for customizing and/or removing and replacing the thermally controlled instrument enclosure [100] and heated liner system for a field instrument attached to the process line tubing [111,112] without detaching the field instrument from the standpipe or other support structure or from the process line tubing [111,112].

FIG. 8B provides a cross-section of the thermally controlled instrument enclosure in a closed position having a single field instrument affixed to a standpipe [104, not shown], either directly or via an instrument rail [817], is provided as located within the arched recess [107]. In the closed position, the heated liner top assembly [400 or 500] the sliding hinge is in the down position and fastened to the heated liner bottom assembly via the sliding hinge fastener [139]. The sliding hinge slides on the top sliding hinge fastener allowing the instrument enclosure to remain in an open position once opened.

The closed configuration provides the fitment of the bottom heater cable exit and the top heater cable exit without interference from features or additions to the instrument enclosure [100], allowing the heat trace cable to access the cable access ports (not shown) on the standpipe.

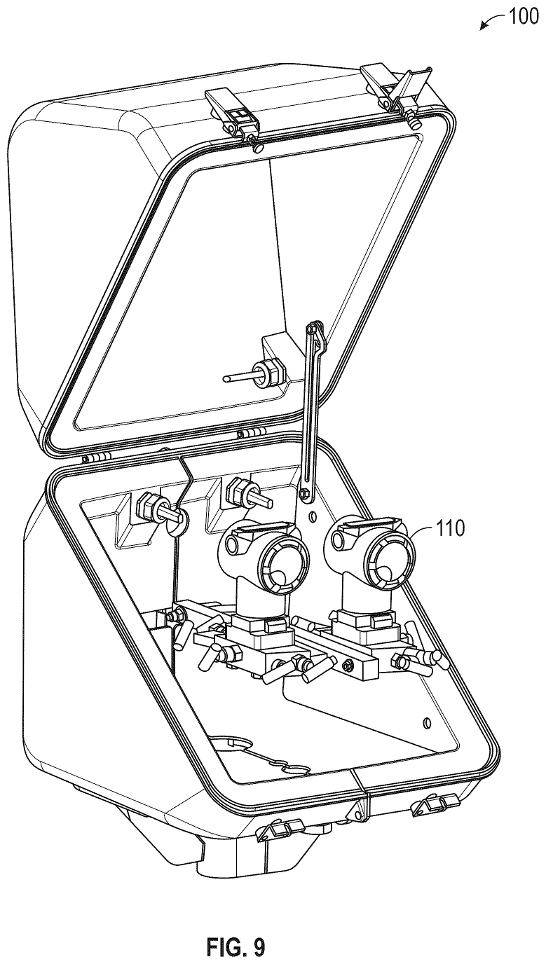

The selected field instrument(s) can be installed within the instrument enclosure in single instrument configuration as shown in FIGS. 1, 2, 8 and 8A or multiple instrument configurations as provided in FIG. 9.

Supporting the field instrument may include one or more operations including: attaching the field instrument to the standing structure, wherein the instrument enclosure defines an aperture configured to receive a terminal portion the standing structure and attaching the field instrument to one or more attachment features of the instrument enclosure.

WORKING EXAMPLE: The ability of a thermally controlled instrument enclosure to maintain temperature within the internal enclosure space was measured in a laboratory setting.

Using a Thermotron 2800 temperature controller the temperature was measured at −29.6° C. inside the testing chamber. Temperature readings of 61.1288° C. inside the box, 65.5694° C. on the metal wire, and 14.6860° C. on the standpipe were obtained. Confirmation of the maintenance of an ambient condition inside the enclosure within +5° C. of the heat trace cable temperature while removing the ability of the standpipe to act as a heat sink.

I claim:

1. One or more instrument enclosures, comprising: a top section casing with a first, second, third, and fourth edge and a bottom section casing with a first, second, third, and fourth edge, wherein said first edge of said bottom section casing is hinged and/or rotatably-affixed to said first edge of said top section casing via one or more hinges and wherein second, third, and fourth edges of said top casing section are in contact with or in close proximity to said second, third, and fourth edges of said bottom section casing that provides an insulating housing that includes individual interchangeable parts that provide a portion of or completed separate attachable interior liner and exterior cap for said housing that encloses at least a portion of said instrument enclosures such that one or more instruments within said enclosures are temperature controlled and wherein said enclosures are rotatable and wherein one or more hinges are configured to enable both said top section casing and said bottom section casing to rotate between a close positioned and one or more open positions.

2. The instrument enclosures of claim 1, wherein said separate interior liner of said housing is comprised of either a stamped liner with tabs stamped through said liner for attachment of at least two separate pieces to said separate interior liner and/or a welded liner with tabs welded on a backside of said separate interior liner so that either or both stamped and welded liners are heated and/or cooled as required and wherein a separate interior insulated liner insulates and moderates a temperate environment without use of a heater or cooler.

3. The instrument enclosures of claim 1, wherein heating is achieved with heater cables, heating elements, finned heaters, printed circuit heaters, a heater hanger, wherein heat is provided via electrical wires, conduction and/or convection.

4. The instrument enclosures of claim 1, wherein cooling is achieved by air conditioning, cooling fans, vortex tubes that are also a portion of a separate and attachable liner.

5. The instrument enclosures of claim 1, wherein hinges between said top section casing and said bottom section casing along first edges of said top section casing and said bottom section casing includes additional hinging between top casing and bottom casing sections that provides multiple variations of open and closed configurations of said instrument enclosures wherein said additional hinging includes fixed and/or detachable hinging between any of second, third, and fourth edges.

6. The instrument enclosures of claim 1, wherein a first part of said bottom section casing possesses a first notch; a second part of said bottom section casing possesses a second notch; and wherein said first notch and said second notch are configured to define an opening in said bottom section casing.

7. The instrument enclosures of claim 1, wherein an opening in said bottom section casing is configured to accept and connect with a standpipe and wherein said standpipe is attached to said bottom section casing and/or resides within an instrument enclosure.

8. The instrument enclosures of claim 4, wherein:
one or more interior surfaces of said bottom section casing includes one or more instrument attachment elements that allow for attachment to, removal of, and/or rotation for a field instrument to said bottom section casing; and
wherein said enclosed space exists to receive one or more field instruments removably attached to said bottom section casing.

9. The instrument enclosures of claim 2, wherein an opening in said bottom section casing is configured to receive one or more process line conduits that convey one or more measurable process parameters to said one or more field instruments.

10. The instrument enclosures of claim 6, wherein: said one or more process line conduits are enclosed in-process line tubing; and said opening in said bottom section casing is configured to engage said process line tubing.

11. The instrument enclosures of claim 1, wherein:
a first portion of said bottom section casing defines a first pipe notch and a first line notch;
and a second portion of said bottom section casing defines a second pipe notch and a second line notch such that said first pipe notch and said second pipe notch are configured to define a standpipe opening in said bottom section casing such that said standpipe opening is configured to engage said standpipe; and wherein said first line notch and said second line notch are configured to define a process line opening in said bottom section casing;
wherein said process line opening is configured to receive process line tubing enclosing one or more process line signals conveying one or more process line parameters to said one or more field instruments.

12. The instrument enclosures of claim 1, wherein: said bottom section casing is configured to be fastened to bracket affixed to the standpipe;
wherein said bracket includes a plurality of openings suitable for receiving fasteners; and wherein
said bottom section casing includes a plurality of openings corresponding to said plurality of openings in said bracket.

13. The instrument enclosures of claim 1, wherein, said instrument enclosures comprise a convex polyhedral instrument enclosure.

14. The instrument enclosures of claim 13, wherein said convex polyhedral instrument enclosures comprise a hexahedral instrument enclosure comprising six planar surfaces including an upper surface, a lower surface, a forward surface, a rearward surface, a left surface, and a right surface.

15. The instrument enclosures of claim 14, wherein:
said top section casing includes an upper surface, a forward surface, a first portion of a left surface, and a first portion of a right surface; and said bottom section casing includes a lower surface, a rearward surface, a second portion of a left surface, and a second portion of a right surface.

16. The instrument enclosures of claim 12, wherein: said first part of said bottom section casing includes a first portion of the lower surface, a first portion of the rearward surface, and the second portion of the left surface; and a second part of said bottom section casing includes a second portion of said lower surface, a second portion of said rearward surface, and a second portion of said right surface.

17. The instrument enclosures of claim 16, wherein said first portion of said lower surface comprises a first half portion of said lower surface; said second portion of said lower surface comprises a second half portion of said lower surface said first portion of said rearward surface comprises a first half or said rearward surface and said second portion of said rearward surface comprises a second half of said rearward surface.

18. The instrument enclosures of claim 17, wherein at least one planar surface of said instrument enclosures contains one or more windows that are transparent and exhibit durability that minimize or eliminate breakage of said windows.

19. The windows of claim 18, wherein said windows are composed of tempered glass.

20. A method of providing one or more instrument enclosures that enclose and protect and keep one or more field instruments at a desired location within a moderate temperate climate, said method comprising:
hinging a hinged section of an instrument enclosure to a vertical support section that is self-standing and/or secured to stand vertically, including a standpipe, located in said desired location wherein said hinging enables said hinged section to rotate relative to said vertical support section between a closed position and one or more open positions of said instrument enclosures such that one or more instruments mounted within said one or more instrument enclosures are also capable of rotation or other position adjustments and wherein a combination of said vertical support section and said hinged section, in a closed position defines an enclosed space that is dimensioned to receive said one or more field instruments and wherein said one or more instrument disclosures are constructed in order to provide a protective barrier a separate partitioned and interchangeable parts insulated liner is constructed that can be either heated or cooled if needed and exists between an enclosed space and an external environment wherein said instrument enclosures are located such that protective barrier shields and moderated temperatures of said enclosed space from one or more environmental elements;
and;
affixing said one or more field instruments to one or more supporting structures wherein said field instruments are disposed in a desired, particular position within said enclosed space such that said instrument enclosure is attached to said vertical support section wherein said hinged section is hinged to said vertical support section and said instrument enclosures are enclosed within a closed portion of said instrument enclosures.

21. The method of claim 17, wherein a sequence of performing said hinging, said attaching, and said supporting includes a sequence selected from the group consisting of:
hinging, attaching, and supporting; attaching, hinging, and
supporting; supporting, hinging, and attaching; and
supporting, attaching, and attaching.

22. The method of claim 18, further comprising: forming the fixed section by fastening a first part of the hinged section to a second part of the hinged section.

23. The method of claim 19, wherein supporting field instruments comprise performing an operation to provide support from the group consisting of:
attaching said field instruments to said vertical support structure, wherein said instrument enclosure defines an aperture configured to receive a terminal portion of said vertical support structure; allowing for rotation and/or other positioning of said field instruments within said instrument enclosures and attaching said field instruments to one or more attachment features of the instrument enclosure.

24. An adjustable assembly comprising; at least one enclosure portion that provides an internal or external housing of one or more instruments with an insulating housing that includes individual interchangeable parts that provide a portion of or completed separate attachable interior liner and exterior cap for said internal or external housing and one or more heater elements that are enclosed by at least one main heater or one main cooler body assembly wherein said main heater and cooler body assemblies includes at least one or more hooked projections wherein said hooked projections are shaped in an inverted L-shaped arrangement and wherein said hooked projections are attached to at least one lateral or at least one medial or both lateral and medial sides of a center portion of said main heater body assembly and wherein said finned heater body includes one or more positional openings that allow for containment of said heater element and concurrently provide a spatial geometric arrangement so that said one or more hooked projections provide an ability for said finned heater body and said internal or external housing of one or more instruments to be hung in adjustable manner from a mounting bracket that is attached to a post or pipe stand.

25. The adjustable assembly of claim 24, wherein said mounting bracket attached to said post or pipe stand comprises two semi-circumferential left and right mounting bracket sections that can be mated, wherein each section is contoured to fit around said pipe stand and is secured tightly to said pipe stand.

26. The adjustable assembly of claim 24, wherein said pipe stand is provided with an adjustable or non-adjustable pipe stand clamp so that said enclosure assembly and said mounting bracket can be located at an optimal location and/or height along a length of said pipe stand.

27. The adjustable assembly of claim 24, wherein said finned heater body is an assembly that also includes hooked projections that extend from a center portion of said finned heater body to provide an ability for said finned heater body to be hung from said mounting bracket by utilization of inverted L-shaped hooked projections.

28. The adjustable assembly of claim 24, wherein said two semi-circumferential mounting bracket sections provides a U-shaped body that is contoured in order to provide a geometric fit and attachment to said pipe stand.

29. The adjustable assembly of claim 24, wherein said two semi-circumferential mounting bracket sections are secured to said pipe stand with a tensioning fastener that allows for adjustable pinning and tightening of said two mated semi-circumferential mounting brackets to said pipe stand.

30. The adjustable assembly of claim 29, wherein an engagement lip is created that surrounds said U-shaped body so that said finned heater body can be hung anywhere along a 360-degree perimeter of said engagement lip and wherein said engagement lip is completed after said two mated semi-circumferential mounting bracket sections are mated.

31. The adjustable assembly of claim 30, wherein said two semi-circumferential mounting bracket sections with said U-shaped body have an inner contour portion on each of two semi-circumferential halves and an outer contour portion located on an outside portion of said U-shaped body, wherein said outer contour portion is located in a position further way from said pipe stand such that an offset from said inner contour portion of said two mated semi-circumferential mounting bracket sections creates at least a portion of said engagement lip to enable said engagement lip to complete a 360-degree circumference around two semi-circumferential mounting bracket sections.

32. The adjustable assembly of claim 25, wherein one or more instruments are also mounted by an attachment to two circumferential instrument mounting brackets with two halves that are shaped with a contour so that said that two circumferential instrument mounting brackets can be mated and attached to said pipe stand via a tensioning fastener.

33. The adjustable assembly of claim 25, wherein both said one or more instruments and said one or more heater elements are mounted either within or external to one or more enclosure portions and wherein one or more heater elements are enclosed by at least one main heater body assembly surrounded by and attached to heat transfer fins to provide a finned heater body and wherein two or more mounting brackets secure both said one or more instruments and one or more heater body assemblies to said pipe stand and wherein attachment to an existing mounting can either be added or removed without dismantling other portions of said field mountable instrument heater.

34. The adjustable assembly of claim 25, wherein at least two semi-circumferential left and right mounting bracket sections that can be mated can also be rectangular or in another shape configured to secure said one or more instruments and one or more heater elements to said pipe stand.

35. The adjustable assembly of claim 34 wherein said tensioning fasteners are selected from at least one of a group consisting of clamps, braces, grips, vices, clips, screws, and bolts.

36. A field mountable instrument heater comprising; at least three components that fit together in at least one adjustable configuration, wherein said at least three components include two components that are adjustable to accommodate and attach to a pipe stand or mounting post and wherein a third component is a housing with an insulating housing that includes individual interchangeable parts that provide a portion of or completed separate attachable interior liner and exterior cap for said internal or external housing and one or more heater elements that are enclosed by at least one main heater or one main cooler body assembly wherein said main heater and cooler body assemblies includes at least one or more hooked projections wherein said hooked projections are shaped in an inverted L-shaped arrangement and wherein said hooked projections are attached to at least one lateral or at least one medial or both lateral and medial sides of a center portion of said main heater body assembly and wherein said finned heater body includes one or more positional openings that allow for containment of said heater element and concurrently provide a spatial geometric arrangement so that said one or more hooked projections provide an ability for said finned heater body and said internal or external housing of one or more instruments to be hung in adjustable manner from a mounting bracket that is attached to a post or pipe stand.

37. A method for installing and using an adjustable assembly comprising; at least one enclosure portion that provides an internal or external housing of one or more instruments and one or more heater elements that are enclosed by at least one main heater body assembly surrounded by and attached to heat transfer fins to provide a finned heater body wherein said main heater body assembly includes at least one or more hooked projections wherein said hooked projections are shaped in an inverted L-shaped arrangement and wherein said hooked projections are attached to at least one lateral or at least one medial or both lateral and medial sides of a center portion of said main heater body assembly and wherein said finned heater body includes one or more positional openings that allow for containment of said heater element and concurrently provide a spatial geometric arrangement so that said one or more hooked projections provide an ability for said finned heater body and said internal or external housing of one or more instruments to be hung in adjustable manner from a mounting bracket that is attached to a post or pipe stand, wherein said method allows for removing, adding, installing, and using instruments in a controlled and regulated either heated or unheated environment without requiring any disassembly and/or reassembly of any items along said pole stand.

38. The method of claim 37, wherein said mounting bracket attached to said post or pipe stand comprises two semi-circumferential left and right mounting bracket sections that can be mated, wherein each section is contoured to fit around said pipe stand and is secured tightly to said pipe stand.

39. The method of claim 37, wherein said pipe stand is provided with an adjustable or non-adjustable pipe stand clamp so that said enclosure assembly and said mounting bracket can be located at an optimal location and/or height along a length of said pipe stand.

40. The method of claim 37, wherein said finned heater body is an assembly that also includes hooked projections that extend from a center portion of said finned heater body to provide an ability for said finned heater body to be hung from said mounting bracket by utilization of inverted L-shaped hooked projections.

41. The method of claim 37, wherein said two semi-circumferential mounting bracket sections provides a U-shaped body that is contoured in order to provide a geometric fit and attachment to said pipe stand.

42. The method of claim 37, wherein said two semi-circumferential mounting bracket sections are secured to said pipe stand with a tensioning fastener that allows for adjustable pinning and tightening of said two mated semi-circumferential mounting brackets to said pipe stand.

43. The method of claim 37, wherein an engagement lip is created that surrounds said U-shaped body so that said finned heater body can be hung anywhere along a 360-degree perimeter of said engagement lip and wherein said engagement lip is completed after said two mated semi-circumferential mounting bracket sections are mated.

44. The method of claim 37, wherein said two semi-circumferential mounting bracket sections with said U-shaped body have an inner contour portion on each of two semi-circumferential halves and an outer contour portion located on an outside portion of said U-shaped body, wherein said outer contour portion is located in a position further way from said pipe stand such that an offset from said inner contour portion of said two mated semi-circumferential mounting bracket sections creates at least a portion of said engagement lip to enable said engagement lip to complete a 360-degree circumference around two semi-circumferential mounting bracket sections.

45. The method of claim 37, wherein one or more instruments are also mounted by an attachment to two circumferential instrument mounting brackets with two halves that are shaped with a contour so that said that two circumferential instrument mounting brackets can be mated and attached to said pipe stand via a tensioning fastener.

46. The method of claim 37, wherein both said one or more instruments and said one or more heater elements are mounted either within or external to one or more enclosure portions and wherein one or more heater elements are enclosed by at least one main heater body assembly surrounded by and attached to heat transfer fins to provide a finned heater body and wherein two or more mounting brackets secure both said one or more instruments and one or more heater body assemblies to said pipe stand.

47. The method of claim 37, wherein at least two semi-circumferential left and right mounting bracket sections that can be mated can also be rectangular or in another shape configured to secure said one or more instruments and one or more heater elements to said pipe stand.

48. The method of claim 37, wherein said tensioning fasteners are selected from at least one of a group consisting of clamps, braces, grips, vices, clips, screws and bolts.
